(19) United States
(12) Patent Application Publication
(10) Pub. No.: US 2015/0051330 A1
(43) Pub. Date: Feb. 19, 2015

(54) 3D PRINTING POWDER

(71) Applicant: Jung Huei Enterprise Co., Ltd., Tainan City (TW)

(72) Inventor: TSAN-TANG FANG, TAINAN CITY (TW)

(73) Assignee: Jung Huei Enterprise Co., Ltd., Tainan City (TW)

(21) Appl. No.: 13/968,660

(22) Filed: Aug. 16, 2013

(51) Int. Cl. C09D 5/03; C09D 7/12

(52) U.S. Cl. CPC C09D 5/033; C09D 7/1216
USPC 524/423

(57) ABSTRACT

The present invention discloses a 3D printing powder produced by laying a gypsum powder; coating a water-soluble resin powder on the gypsum powder, and the water-soluble resin powder forming a colloid in water; pressing the water-soluble resin powder and the gypsum powder flatly to form a mixed layer; and adding water to the mixed layer. The mixed layer formed by using a water-soluble resin powder such as oxazoline resin, polyoxyethylene, or polyvinyl alcohol and pressing the water-soluble resin powder with the gypsum powder, so that the structural strength of 3D printing finished goods can be improved for several times, and the finished goods will not be deformed by external forces or smudged by colorants easily, and the finished goods can have smooth surfaces.

### BACKGROUND OF THE INVENTION

1. Field of the Invention

The present invention generally relates to a 3D printing powder, in particular to the 3D printing powder capable of improving the structural strength of a 3D printing products preventing the 3D printing product from being deformed by a force or having a color smudge, and making the surface of the product relatively smoother.

2. Description of the Related Art

Rapid prototyping (RP) is a technology used for forming molds or components by 3D printing and this technology has been used extensively in different fields. In general, a 3D printing powder is mixed with a gypsum powder and a soluble resin, and the soluble resin is excited in water and adhered with the gypsum powder. Since gypsum has a rigid structure, therefore the rigidity of a 3D printing product can be enhanced. Although gypsum comes with a relatively hard nature, yet it can be cracked easily. Recent experiments and literature show that the flexural strength and impact resistance of gypsum can be enhanced by adding a soluble resin such as polyvinyl alcohol, acrylic resin, or urea formaldehyde resin, and then adding water into the soluble resin and mixing the mixture sufficiently to achieve the effect of improving the rigidity of the products. Further, an appropriate amount of bridging agent can be added to change the structure of the soluble resin into a mesh thermal setting structure, so as to further enhance the strength and water resistance. Thus, many manufacturers adopt the aforementioned method for 3D printing.

As to a conventional 3D printing process, a gypsum powder is mixed with a soluble resin powder to form a mixed powder, and then the mixed powder is laid before it is pressed by a roller, and finally water is added, and layers of the mixed powder are stacked. Till the gypsum powder is hydrated and cured, a 3D printing product is produced.

However, the soluble resin is usually not mixed sufficiently after water is added during the conventional 3D printing process, so that the gypsum powder and the soluble resin powder can absorb water independently, and the efficiency of water absorption is relatively low, and the water may be permeated to the outside easily. As a result, when the mixed powder is laid again during the 3D printing process, the 3D printing product is deformed or smudged by the permeated water, and the 3D printing product fails to comply with the original design requirements. Furthermore, it is difficult to dissolve the soluble resin powder completely, so that its interactivity with the gypsum powder will become lower, and the structure will form an asbestos-like structure with a low flexural strength easily as shown in FIG. 1. According to a standard flexural strength test, a hollow section 101 with a length L₀ of 40 mm is formed within a support platform 10, and a printing product 20 with a length L of 60 mm, a width W of 15 mm and a height H of 5 mm is placed on the support platform, so that both long sides of the 3D printing product 20 at the support platform 10 have a support length of L₁ of 10 mm, and a force F can be applied at the center of the 3D printing product 20 to break the 3D printing product 20, and the force F is defined as the flexural strength of the 3D printing product 20. However, the conventional 3D printing product 20 has a flexural strength less than 1000 gw, and the product 20 may be cracked by forces easily, and thus affecting the overall quality of the 3D printing product. In addition, the gypsum powder used in the 3D printing process has a grain size between 5 μm to 100 μm which is smaller than 10 μm, so that the gypsum powder may be blown away by wind easily, and users may inhale the gypsum powder during the 3D printing process, and thus affecting the health of the users.

In view of the aforementioned problems, the inventor of present invention developed a 3D printing powder to improve the 3D printing process and overcome the problems of the prior art.

### SUMMARY OF THE INVENTION

Therefore, it is a primary objective of the present invention to overcome the problems of the gypsum powder being blown easily and affecting the user's health during the conventional 3D printing process, having a poor interaction and an insufficient reaction between the gypsum powder and the soluble resin powder during the manufacture of 3D printing products, so that the 3D printing product may have a color smudge easily and the soluble resin may not be dissolved completely. Obviously, the 3D printing product has the shortcomings of insufficient rigidity and strength and poor quality.

To achieve the foregoing objective, the present invention provides a 3D printing powder, comprising a gypsum powder; and a water-soluble resin powder coated onto the gypsum powder, wherein the water-soluble resin powder and the gypsum powder are pressed flatly to form a mixed powder, and the water-soluble resin powder forms a colloid in water and the water-soluble resin powder is selected from the group of oxazoline resin and polyoxyethylene.

Wherein, the water-soluble resin powder has a percentage by weight from 5% to 15%.

Wherein, the 3D printing powder further comprises a whitener.

Wherein, the whitener of the 3D printing powder is a titanium dioxide powder.

Wherein, the titanium dioxide powder has a percentage by weight from 0.1% to 0.5%.

The present invention provides a water-soluble resin powder for 3D printing, and the water-soluble resin powder forms a colloid in water, and the water-soluble resin powder is oxazoline resin.

Wherein, the water-soluble resin powder further comprises a whitener.

Wherein, the whitener of the water-soluble resin powder for 3D printing is a titanium dioxide powder.

Wherein, the water-soluble resin powder is coated onto a body filler powder and provided for curing the body filler powder to form the colloid.

The present invention provides a 3D printing powder comprising a gypsum powder; and a water-soluble resin powder having a percentage by weight from 5% to 15% and coated onto the gypsum powder, wherein the water-soluble resin powder and the gypsum powder are pressed to form a mixed powder, and the water-soluble resin powder forms a colloid in water and the water-soluble resin powder is polyvinyl alcohol.

Wherein, the 3D printing powder further comprises a bridging agent.

Wherein, the bridging agent of the 3D printing powder is a boron bridging agent.

Wherein, the boron bridging agent of the 3D printing powder has a percentage by weight from 0.05% to 0.4%.

Wherein, the 3D printing powder further comprises a whitener.

Wherein, the whitener of the 3D printing powder is a titanium dioxide powder.

Wherein, the titanium dioxide powder of the 3D printing powder has a percentage by weight from 0.1% to 0.5%.

In view of the aforementioned description and method, the present invention has the following advantages and effects:

1. In the present invention, water is added into the water-soluble resin such as oxazoline resin, polyoxyethylene or polyvinyl alcohol. If the water-soluble resin is polyvinyl alcohol, then a boron bridging agent can be added to enhance the flexural strength of the 3D printing product of the present invention up to 2000 gw or more. Obviously, the strength of the products of the present invention is much greater than those of the prior art, and thus the invention can improve the quality of 3D printing products.

2. In the present invention, the gypsum powder is laid, and then the water-soluble resin powder is coated onto the gypsum powder before the water-soluble resin powder and the gypsum powder are pressed flatly to form a mixed powder. When water is added into the mixed powder, water enters into the gypsum powder and will not be permeated to the outside easily, and thus the invention can prevent water from entering the 3D printing product, since the water may cause deformations and color smudges at spaces beyond the design, and the water-soluble resin powder may absorb water to become a colloid more easily, such that the particles of the gypsum powder are denser, and will not adhere powder or have deformations after the gypsum powder is cured. As a result, the surface of the product of the invention is smooth and flat, and thus the invention can enhance the strength and quality of 3D printing products effectively.

3. In the present invention, the gypsum powder is laid, and then the water-soluble resin powder is coated onto the gypsum powder, so that the grain size of the gypsum powder falls within a range from 15 μm to 100 μm. Since a powder with the grain size smaller than 10 μm may be blown by wind easily, therefore the present invention can reduce the chance of blowing the relatively larger gypsum powder of the invention and the chance of inhaling the gypsum powder by users.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic view of testing the flexural strength of a 3D printing product;

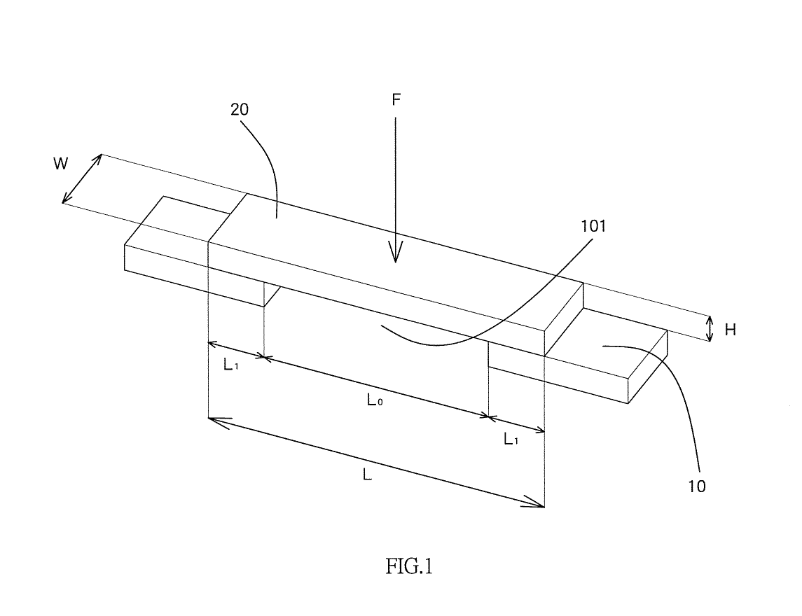

FIG. 2 is a schematic view of coating a gypsum powder onto a water-soluble resin powder and pressing the powders by a roller in accordance with the present invention; and

FIG. 3 is a schematic view of pressing a gypsum powder and a water-soluble resin powder to form a mixed powder in accordance with the present invention.

### DETAILED DESCRIPTION OF THE PREFERRED EMBODIMENTS

The technical content of the present invention will become apparent by the detailed description of the following embodiments and the illustration of related drawings as follows.

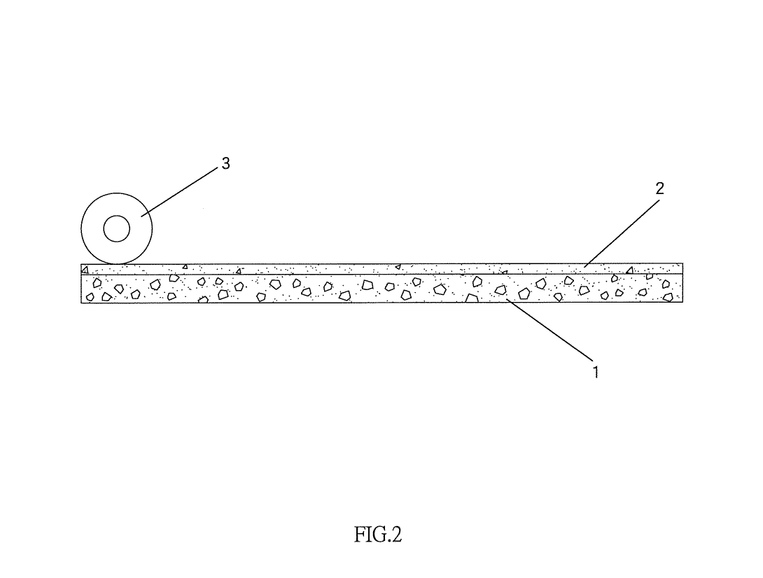

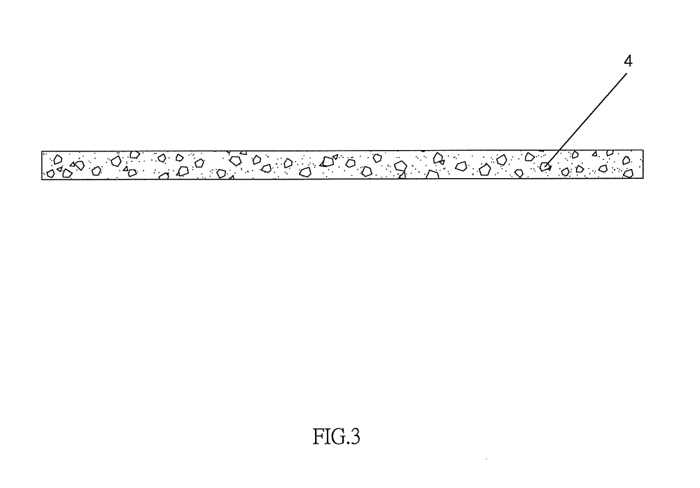

With reference to FIGS. 2 and 3, for a 3D printing powder in accordance with a first preferred embodiment of the present invention, the composition and the operation procedure of the present invention are described below:

(a) In Table 1, the gypsum powder 1 of this preferred embodiment has a percentage by weight from 85% to 95%.

(b) The gypsum powder 1 is coated on a thinner water-soluble resin powder 2, and the water-soluble resin powder 2 forms a colloid in water, and the water-soluble resin powder 2 of this preferred embodiment is oxazoline resin with a percentage by weight from 5% to 15%. Since the water-soluble resin powder 2 is coated onto the gypsum powder 1, therefore the gypsum powder 1 should have a grain size from 15 μm to 100 μμm in order to prevent it from being blown by wind and reduce the probability of the gypsum powder 1 being inhaled by users to maintain the health and safety of the users.

(c) A roller 3 is used for pressing the water-soluble resin powder 2 and the gypsum powder 1 to form a mixed powder 4 as shown in FIG. 3, so that the water-soluble resin powder 2 and the gypsum powder 1 are combined tightly with each other.

(d) Water is added into the mixed powder 4. Since the mixed powder 4 has been pressed by the roller 3, therefore gaps between the water-soluble resin powder 2 and the gypsum powder 1 are smaller to provide a tighter structure, and water cannot be permeated between particles of the gypsum powder 1, and the coated gypsum powder 1 tends to have deformations or a color smudge at the spaces beyond the design, such that the water-soluble resin powder 2 can be adhered to form a colloid easily, and the grain size of particles of the cured gypsum powder 1 is denser. The procedure is repeated to produce the 3D printing product. Experiment results show that the 3D printing product of the present invention has a structural strength much greater than the prior art that adds gypsum into the soluble resin to directly form the mixed powder and adds water and cures the mixture. Therefore, the flexural strength of the 3D printing product can be enhanced up to 2000 gw or more, and the surface of the 3D printing product is smoother. In addition, this preferred embodiment adopts oxazoline resin as the water-soluble resin powder 2, and the colloid formed by adding water to oxazoline resin has an excellent curing power. As a result, the flexural strength of the 3D printing product can be enhanced, regardless of the material of the body filler powder (which is gypsum powder used in this preferred embodiment).

In the second preferred embodiment of the present invention, the whiteness of the 3D printing product of the first preferred embodiment can be improved by mixing a whitener into the water-soluble resin powder 2. In this preferred embodiment, the whitener is titanium dioxide powder with a percentage by weight from 0.1% to 0.5%, or oxazoline resin with a percentage by weight from 5% to 15%, so that the percentage by weight of gypsum powder 1 is adjusted to 84.5% to 94.9% as listed in Table 1, so as to maintain the structural strength and the whiteness of the 3D printing product. The implementation procedure of this preferred embodiment is similar to that of the first preferred embodiment, and thus will not be repeated.

TABLE 1

| | First | Second |
|---|---|---|
| 3D Printing | Embodiment | Embodiment |
| Powder | (% wt) | (% wt) |
| Gypsum Powder | 85~95 | 84.5~94.9 |
| Oxazoline resin | 5~15 | 5~15 |
| Titanium Dioxide | 0 | 0.1~0.5 |
| Powder | | |

The difference between the third preferred embodiment and the first preferred embodiment of the present invention resides on that the third preferred embodiment adopts polyoxyethylene as the water-soluble resin powder 2, wherein the polyoxyethylene has a percentage by weight from 5% to 15%, and the gypsum powder 1 has a percentage by weight from 85% to 95% as listed in Table 2, and thus the third preferred embodiment also can enhance the flexural strength of the 3D printing product flexural strength. The implementation procedure of this preferred embodiment is similar o that of the first preferred embodiment, and thus will not be repeated.

In the fourth preferred embodiment of the present invention, the whiteness of the 3D printing product of the first preferred embodiment can be improved by mixing a whitener into the water-soluble resin powder 2. In this preferred embodiment, the whitener is titanium dioxide powder with a percentage by weight from 0.1% to 0.5%, and polyoxyethylene has a percentage by weight from 5% to 15%, so that the percentage by weight of the gypsum powder 1 is adjusted to a range from 84.5% to 94.9%, so as to maintain the structural strength and the whiteness of the 3D printing product. The implementation procedure of this preferred embodiment is similar to that of the first preferred embodiment, and thus will not be repeated.

TABLE 2

| | Third | Fourth |
|---|---|---|
| 3D Printing | Embodiment | Embodiment |
| Powder | (% wt) | (% wt) |
| Gypsum Powder | 85~95 | 84.5~94.9 |
| Polyoxyethylene | 5~15 | 5~15 |
| Titanium Dioxide | 0 | 0.1~0.5 |
| Powder | | |

The difference between the fifth preferred embodiment and the first preferred embodiment of the present invention resides on that the fifth preferred embodiment adopts polyvinyl alcohol as the water-soluble resin powder 2, wherein the polyvinyl alcohol has a percentage by weight from 5% to 15%, and the gypsum powder 1 has a percentage by weight from 85% to 95% as listed in Table 3, so as to maintain the structural strength and the whiteness of the 3D printing product. The implementation procedure of this preferred embodiment is similar to that of the first preferred embodiment, and thus will not be repeated.

The difference between the sixth preferred embodiment and the fifth preferred embodiment of the present invention, the sixth preferred embodiment further increases the strength of the 3D printing product by using polyvinyl alcohol as the water-soluble resin powder 2, and a bridging agent is mixed into the polyvinyl alcohol, wherein the bridging agent of this preferred embodiment is a boron bridging agent with a percentage by weight from 0.05% to 0.4%, and the polyvinyl alcohol has a percentage by weight from 5% to 15%, and the percentage by weight of the gypsum powder 1 is adjusted to 84.6% to 94.95% as listed in Table 3, so as to maintain the structural strength of the 3D printing product. The implementation procedure of this preferred embodiment is similar to that of the first preferred embodiment, and thus will not be repeated.

To improve the whiteness of the fifth preferred embodiment, a whitener is mixed into the polyvinyl alcohol in the seventh preferred embodiment of the present invention. In this preferred embodiment, the whitener is titanium dioxide powder with a percentage by weight from 0.1% to 0.5%, and the polyvinyl alcohol has a percentage by weight from 5% to 15%, so that the percentage by weight of the gypsum powder 1 is adjusted to 84.5% to 94.9% as listed in Table 3, so as to maintain the structural strength and the whiteness of the 3D printing product. The implementation procedure of this preferred embodiment is similar to that of the first preferred embodiment, and thus will not be repeated.

To improve the whiteness of the sixth preferred embodiment, a whitener is mixed into the polyvinyl alcohol in the eighth preferred embodiment of the present invention. In this preferred embodiment, the whitener is a titanium dioxide powder with a percentage by weight from 0.1% to 0.5%, and a boron bridging agent has a percentage by weight from 0.05% to 0.4%, and the polyvinyl alcohol has a percentage by weight from 5% to 15%, so that the percentage by weight of the gypsum powder 1 is adjusted to 84.1% to 94.85%, so as to maintain the structural strength and the whiteness of the 3D printing product. The implementation procedure of this preferred embodiment is similar to that of the first preferred embodiment, and thus will not be repeated.

TABLE 3

| | Fifth | Sixth | Seventh | Eighth |
|---|---|---|---|---|
| 3D Printing | Embodiment | Embodiment | Embodiment | Embodiment |
| Powder | (% wt) | (% wt) | (% wt) | (% wt) |
| Gypsum | 85~95 | 84.6~94.95 | 84.5~94.9 | 84.1~94.85 |
| Powder | | | | |
| Polyvinyl | 5~15 | 5~15 | 5~15 | 5~15 |
| alcohol | | | | |
| Boron | 0 | 0.05~0.4 | 0 | 0.05~0.4 |
| Bridging | | | | |
| Agent | | | | |
| Titanium | 0 | 0 | 0.1~0.5 | 0.1~0.5 |
| Dioxide | | | | |
| Powder | | | | |

What is claimed is:

1. A 3D printing powder, comprising:
a gypsum powder; and
a water-soluble resin powder, coated onto the gypsum powder,
wherein the water-soluble resin powder and the gypsum powder are pressed to form a mixed powder, and the water-soluble resin powder forms a colloid in water and the water-soluble resin powder is selected from the group of oxazoline resin and polyoxyethylene.

2. The 3D printing powder of claim 1, wherein the water-soluble resin powder has a percentage by weight from 5% to 15%.

3. The 3D printing powder of claim 1, further comprising a whitener.

4. The 3D printing powder of claim 3, wherein the whitener is a titanium dioxide powder.

5. The 3D printing powder of claim 4, wherein the titanium dioxide powder has a percentage by weight from 0.1% to 0.5%.

6. The 3D printing powder of claim 2, further comprising a whitener.

7. The 3D printing powder of claim 6, wherein the whitener is a titanium dioxide powder.

8. The 3D printing powder of claim 7, wherein the titanium dioxide powder has a percentage by weight from 0.1% to 0.5%.

9. A water-soluble resin powder for 3D printing, forming a colloid in water and the water-soluble resin powder being oxazoline resin.

10. The water-soluble resin powder for 3D printing according to claim 9, further comprising a whitener.

11. The water-soluble resin powder for 3D printing according to claim 10, wherein the whitener is a titanium dioxide powder.

12. The water-soluble resin powder for 3D printing according to claim 9, wherein the water-soluble resin powder is coated onto a body filler powder, and the body filler powder is cured when forming the colloid.

13. A 3D printing powder, comprising:
a gypsum powder; and
a water-soluble resin powder, having a percentage by weight from 5% to 15%, and coated onto the gypsum powder;
wherein the water-soluble resin powder and the gypsum powder are pressed to form a mixed powder, and the water-soluble resin powder forms a colloid in water and the water-soluble resin powder is polyvinyl alcohol.

14. The 3D printing powder of claim 13, further comprising a bridging agent.

15. The 3D printing powder of claim 14, wherein the bridging agent is selected from a boron bridging agent.

16. The 3D printing powder of claim 15, wherein the boron bridging agent has a percentage by weight from 0.05% to 0.4%.

17. The 3D printing powder of claim 13, further comprising a whitener.

18. The 3D printing powder of claim 17, wherein the whitener is a titanium dioxide powder.

19. The 3D printing powder of claim 18, wherein the titanium dioxide powder has a percentage by weight from 0.1% to 0.5%.

20. The 3D printing powder of claim 14, further comprising a whitener.

21. The 3D printing powder of claim 20, wherein the whitener is a titanium dioxide powder.

22. The 3D printing powder of claim 21, wherein the titanium dioxide powder has a percentage by weight from 0.1% to 0.5%.

23. The 3D printing powder of claim 15, further comprising a whitener.

24. The 3D printing powder of claim 23, wherein the whitener is a titanium dioxide powder.

25. The 3D printing powder of claim 24, wherein the titanium dioxide powder has a percentage by weight from 0.1% to 0.5%.

26. The 3D printing powder of claim 16, further comprising a whitener.

27. The 3D printing powder of claim 26, wherein the whitener is a titanium dioxide powder.

28. The 3D printing powder of claim 27, wherein the titanium dioxide powder has a percentage by weight from 0.1% to 0.5%.
